(19) United States
(12) Patent Application Publication
(10) Pub. No.: US 2024/0241717 A1
(43) Pub. Date: Jul. 18, 2024

(54) CLOUD INFRASTRUCTURE-AS-CODE METHODS AND SYSTEMS FOR IMPROVING ACCESS AND VISIBILITY OF USERS ACROSS DIFFERENT FUNCTIONAL GROUPS

(71) Applicant: CDW LLC, Vernon Hills, IL (US)

(72) Inventors: Tige L. Phillips, Rhododendron, OR (US); Philip A. Taylor, Early, TX (US); Roger Mitchell Haney, Austin, TX (US); Maria Collins, Pacific Grove, CA (US)

(21) Appl. No.: 18/416,793

(22) Filed: Jan. 18, 2024

Related U.S. Application Data
(60) Provisional application No. 63/439,834, filed on Jan. 18, 2023.

(51) Int. Cl. G06F 8/71

(52) U.S. Cl. CPC G06F 8/71

(57) ABSTRACT

A computing system includes a processor, an electronic network; and a memory having stored thereon instructions that, when executed by the one or more processors, cause the system to: receive a user command; process the user command; and transmit a status code based on the processing. A non-transitory, computer-readable medium includes computer-executable instructions that, when executed by one or more processors, cause a computer to: receive a user command; process the user command; and transmit a status code based on the processing. A method includes receiving a user command; processing the user command; and transmitting a status code based on the processing

### CROSS-REFERENCE TO RELATED APPLICATIONS

This application claims priority to U.S. Provisional Application No. 63/439,834, entitled CLOUD INFRASTRUCTURE-AS-CODE METHODS AND SYSTEMS FOR IMPROVING ACCESS AND VISIBILITY OF USERS ACROSS DIFFERENT FUNCTIONAL GROUPS, filed on Jan. 18, 2023, and hereby incorporated by reference in its entirety.

### TECHNICAL FIELD

The present disclosure is generally directed to methods and systems for cloud infrastructure-as-code (IAC), and more particularly, to improved architectures for improving access and visibility of cloud computing resources for users across different functional groups.

### BACKGROUND

International Data Corporation (IDC) stated that by 2025, half of all cloud computing customers will be operating in a hybrid cloud environment, as opposed to strictly private or public cloud environments. In general, private clouds are those owned/controlled by the organization, public clouds are clouds wherein computing and other resources are rented from a third party, and hybrid clouds are a mixture of public cloud and private cloud resources. Customers are increasingly focusing their cloud spend on cloud monitoring and analytics, above and beyond their baseline spend on compute or workload resources.

Overall, costs and consumption of hybrid cloud solutions are soaring, unpredictable and often unknown. This results in inefficient use of resources and budget. Companies have made sizable research and development investments to integrate IT products and services into their IT departments, and the shift to hybrid cloud is threatening to render that investment obsolete.

In particular, there is a disconnect between the IT departments of many companies and the hybrid cloud operations of other departments such as software development (Dev) and IT operations (Ops) teams. When combined together in an organization, as is often the case, these teams are known as DevOps. In general, DevOps personnel work in a real time, as-soon-as-possible (ASAP) response environment, whereas IT operates based on historical process and control of the environment. As a result, DevOps teams often create “shadow IT” within their own organizations; deploying cloud environments as needed, to avoid delays often seen when engaging with IT.

The relative agility of DevOps teams has not gone unnoticed by cloud service providers (CSPs), who understand this disconnect and are exploiting it to target DevOps teams and drive cloud adoption at the cost of on-premise environments. Some business leaders view IT departments as having lost relevance. Thus, hybrid cloud decisions are being driven without strategy or understanding of the larger implications. For example, there are other teams/functional groups within modern technology companies (e.g., Cloud Operations (CloudOps), Network Operations (NetOps)) whose activities the IT department would normally coordinate with those of DevOps. Coordination between these teams is essential for many business objectives, in particular, for building scalable hybrid cloud environments. However, with DevOps taking on an outsized role, such coordination is falling by the wayside, with predictable negative impacts on organizational effectiveness, security, efficiency, etc.

Conventional hybrid cloud management tools do not provide native cloud solutions for developers, further dividing the IT and DevOps teams. Such tools also require new patterns and tools to do the same work cloud teams pioneered and developed over the last 10-15 years.

Thus, there is a need for platforms that provide centralized functionality for improving visibility, orchestration/coordination, and automation across teams, tools and environments without reinventing the wheel by forcing developers to completely uproot their existing development practices and processes.

### BRIEF SUMMARY

In one aspect, a computing system for improving access and visualization of one or more cloud computing environments across functional groups includes one or more processors; one or more electronic networks; and a memory having stored thereon instructions that, when executed by the one or more processors, cause the system to: (a) receive, via the one or more electronic networks, a user command with respect to one or both of (i) accessing at least one of the cloud environments, and (ii) visualizing at least one of the cloud environments; (b) process, via the one or more processors, the user command, wherein the processing causes one or more cloud functions to be performed affecting the state of at least one of the cloud environments; and (c) transmit, via the one or more electronic networks, a status code based on the processing of the user command.

In another aspect, a non-transitory, computer-readable medium having stored thereon computer-executable instructions that, when executed by one or more processors, cause a computer to: (a) receive, via the one or more electronic networks, a user command with respect to one or both of (i) accessing at least one of the cloud environments, and (ii) visualizing at least one of the cloud environments; (b) process, via the one or more processors, the user command, wherein the processing causes one or more cloud functions to be performed affecting the state of at least one of the cloud environments; and (c) transmit, via the one or more electronic networks, a status code based on the processing of the user command.

In yet another aspect, a computer-implemented method for improving access and visualization of one or more cloud computing environments across functional groups, the method comprising: (a) receiving, via the one or more electronic networks, a user command with respect to one or both of (i) accessing at least one of the cloud environments, and (ii) visualizing at least one of the cloud environments; (b) processing, via the one or more processors, the user command, wherein the processing causes one or more cloud functions to be performed affecting the state of at least one of the cloud environments; and (c) transmitting, via the one or more electronic networks, a status code based on the processing of the user command.

### BRIEF DESCRIPTION OF THE FIGURES

The figures described below depict various aspects of the system and methods disclosed therein. It should be understood that each figure depicts one embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1A depicts an exemplary computing environment depicting conventional cloud computing infrastructure consumption.

FIG. 1B depicts an exemplary computing environment depicting conventional cloud computing infrastructure visibility.

FIG. 2A depicts an exemplary system for providing access to a cloud computing environment across different functional teams.

FIG. 2B depicts an exemplary system for providing access to cloud native services across different functional teams.

FIG. 2C depicts exemplary graphical user interface forms, according to some aspects of the present techniques.

FIG. 3A depicts an exemplary system for providing visibility of a cloud computing environment across different functional teams.

FIG. 3B depicts exemplary standardized visualizations based on the data in the data lake of FIG. 3A.

FIG. 4 depicts an exemplary high level cloud computing system architecture diagram, according to some aspects of the present techniques.

FIG. 5 depicts an exemplary computing environment, according to some aspects of the present techniques.

FIG. 6 depicts an exemplary computer-implemented method for providing cross-functional access and visibility to one or more cloud computing environments, according to some aspects of the present techniques.

FIG. 7A depicts a graphical user interface depicting custom infrastructure-as-code management solutions available to customers, according to some aspects.

FIG. 7B depicts a customer graphical user interface, according to some aspects.

FIG. 7C depicts a services graphical user interface, according to some aspects.

FIG. 7D depicts an infrastructure-as-code management graphical user interface, according to some aspects.

FIG. 7E depicts an add service infrastructure-as-code graphical user interface, according to some aspects.

FIG. 7F depicts a virtual machine creation graphical user interface, according to some aspects.

FIG. 7G depicts an updated services graphical user interface, according to some aspects.

FIG. 7H depicts a virtual machine detail graphical user interface, according to some aspects.

FIG. 7I depicts a virtual machine configuration graphical user interface, according to some aspects.

The figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

### Overview

The present techniques provide methods and systems for, inter alia, constructing, deploying and managing hybrid cloud computing architectures to improve access and visibility for users across different functional groups.

Hybrid cloud customers are faced with the challenges of managing hybrid cloud environments utilizing a variety of technologies and tools from many vendors and CSPs, as well as the changing face of who in the organization is driving the decisions of where and how workloads are deployed. The present techniques enable new ways for IT departments to provide cloud-like patterns and practices, allowing diverse groups within their organization to operate with consistency. This integration drives efficiencies in both consumption and management of existing investment as well as opening new opportunities for cloud providers and others to expand their respective footprints, become trusted cloud advisors and drive relevance to new business outcomes.

The present techniques improve upon conventional cloud computing platforms by adding automated technological capabilities to enhance workload creation, system operation, system visibility and system control for remediation. The present techniques further include GUI components that enable each team to interact differently with the hybrid cloud computing platform, according to their respective skill level(s). The present techniques enable the organization to gain new abilities, including one consistent view of the organization's environment across various teams. In some aspects, the present techniques include centralizing the source of data corresponding to the hybrid cloud computing environment/platform, while adding different access mechanisms to that data, as compared to conventional cloud computing platforms/environments. Herein, the terms “cloud platform,” “cloud environment” and “cloud architecture” maybe used interchangeably, when referring to the shape or constituency of a hybrid cloud, and one or more instances of such a hybrid cloud design.

The present techniques accommodate both IT and DevOps teams, the latter of which generally drives cloud consumption, to operate in an agreed-upon but adaptive manner. The IT Teams can use GUIs to leverage automation to deploy policy, and DevOps can use code to do the same—all overseen by a set of policy and governance developed to the individual needs of these teams. One important consequence of the present techniques is to resolve the longstanding tension between functional groups (e.g., IT and DevOps teams), in favor of a more cooperative and integrated model.

In some aspects, the present techniques provide real-time or near real-time FSO analysis and capabilities, for example, using application programming interfaces (APIs)/toolkits. Examples of such APIs include Cisco Intersight, Cisco Nexus Dashboard, Application Dynamics, Cisco UCSM, Cisco HyperFlex, Cisco ACI, Thousand Eyes, Cisco Secure Workload Manager, Cisco Uno, VMware, Hashicorp Terraform Cloud, Github/GitLab, etc.

The present techniques may include a management framework that uses real time data collectors that feed a Data Lake, allowing for analysis and correlation of events. Given that this FSO capability is based on APIs, it is possible for customers to have choice and a high degree of flexibility should they have a multi-vendor environment, but still leverage the present techniques for management of their overall hybrid cloud environment. This flexibility drives efficiencies in both consumption and management of existing investments as well as opening new opportunities for integration of hybrid cloud resources and increases the trust between vendors and adopters of hybrid cloud computing services.

Advantageously, the present techniques enable DevOps teams to continue to use the same patterns, practices, and tools that developers use today to deploy, use and administer hybrid clouds, while providing the benefits and basic services of public cloud, among these are: (1) Identity Access Management (IAM) across the hybrid cloud environment; (2) simplified graphical user interfaces (GUIs) for IT and Ops teams learning DevOps patterns; (3) reuse of private internet protocol (IP) space, (mirroring how IT and Ops teams currently use Private Virtual Networks (VPNs)); (4) use of a common IAM across all private infrastructure; (5) usage data collection and history views with full-stack observability (FSO); and (6) an open framework environment for teams to enhance and move forward at their own speed.

### Conventional Cloud Computing Examples

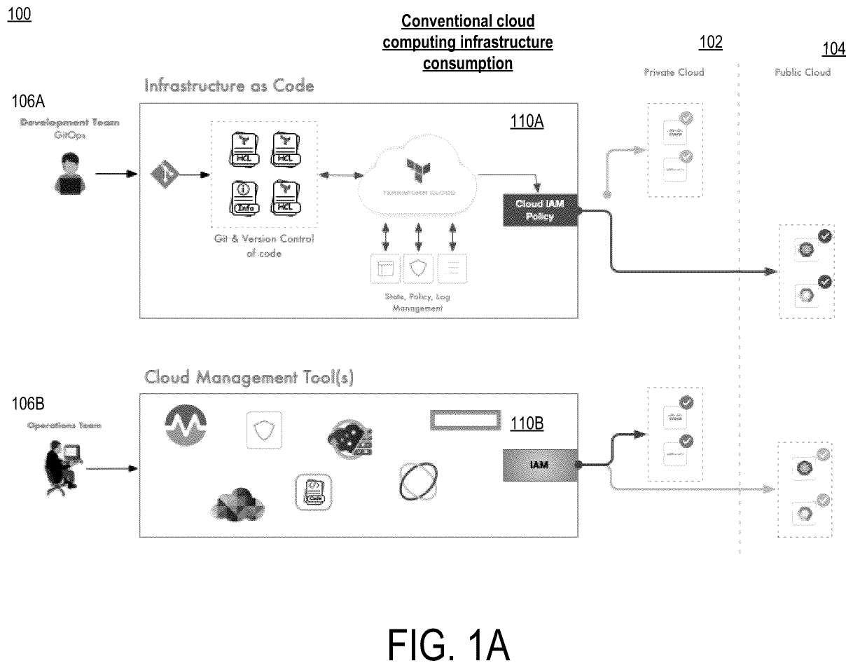

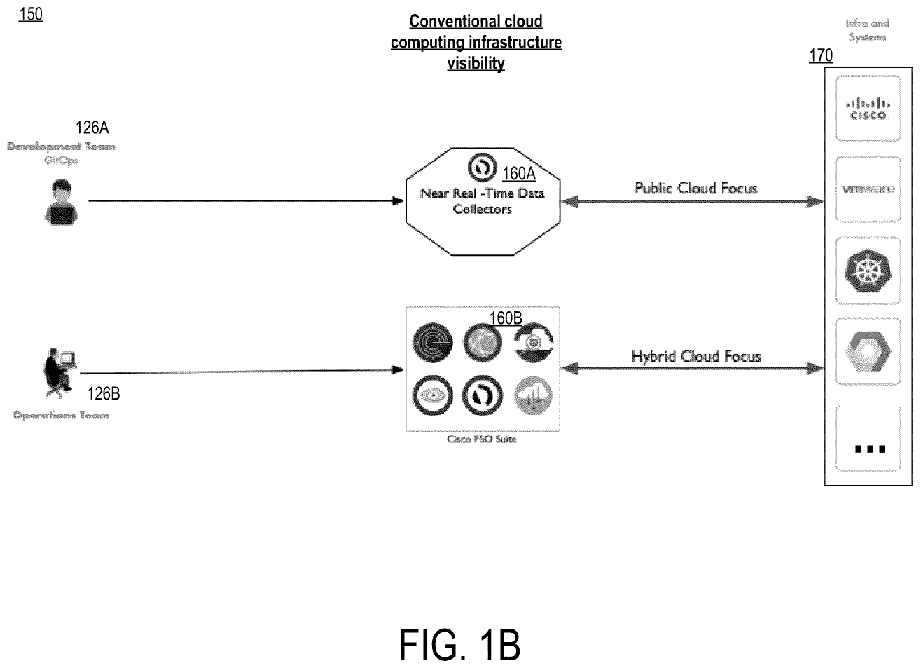

FIG. 1A depicts an exemplary computing environment 100 depicting conventional cloud computing infrastructure consumption. The environment 100 includes a private cloud layer 102 and a public cloud layer 104. The computing environment 100 also includes development team (DevOps) users 106A and operations team (IT) users 106B. The users 106A generally access the private cloud 102 and the public cloud 104 via infrastructure-as-code (IAC) tooling 110A. The users 106B generally access the private cloud 102 and the public cloud 104 via cloud management tooling 110B.

It should be appreciated that the components accessed by the users 106 are in many cases the same resources, as depicted in FIG. 1A. As discussed above, there is tension between development and IT operations teams over differences such as the pace of change and the types of tooling used. However, in the cloud administration context, the results of different tooling on the cloud environment are often times the same.

FIG. 1B depicts an exemplary computing environment 150 depicting conventional cloud computing infrastructure visibility. As is the case with infrastructure consumption, as shown in FIG. 1A, DevOps teams and traditional IT teams may also use different tooling to access cloud computing infrastructures and systems, and such tooling may provide different visibility two distinct sets of users. For example, the computing environment 150 includes a development team 156A that may correspond to the DevOps team 106A of FIG. 1A, and an operations team 156B that may correspond to the IT team 106B of FIG. 1A.

Just as the two different teams of FIG. 1A access the hybrid cloud environment differently, the teams of FIG. 1B have different visibility into the cloud environment, and different functional components that provide such visibility to the respective teams. For example, the DevOps team 126A is primarily focused on accessing infrastructure and systems 170 via a public cloud, as depicted. Public clouds generally include the use of near real-time data collectors for monitoring of the infrastructure and systems 170. For example, FIG. 1B depicts near real time data collector 106A, which is the type of monitoring and logging facility that DevOps users in any organization would generally expect to see, And what their tools would be set up for integration with. On the other hand, conventional IT users typically have more of a hybrid cloud focus wherein they are administering both on premises and public cloud resources in the infrastructure and systems 170. Consequently, this set of users is accessing monitoring and logging information with respect to potentially the same data from the infrastructure and systems 170 as the DevOps team 126A, but the IT operations team 126B has conventionally used an FSO suite to review such data.

In sum, FIG. 1A and FIG. 1B demonstrate that conventional systems architecture is very different for DevOps and IT user groups. Such users conventionally use different tooling to initialize and manage cloud infrastructure, and that tooling lends itself to a very different conceptual understanding/mental model of the cloud infrastructure (including hybrid clouds) among the users of the two groups.

### Exemplary Cloud Computing Access Aspects

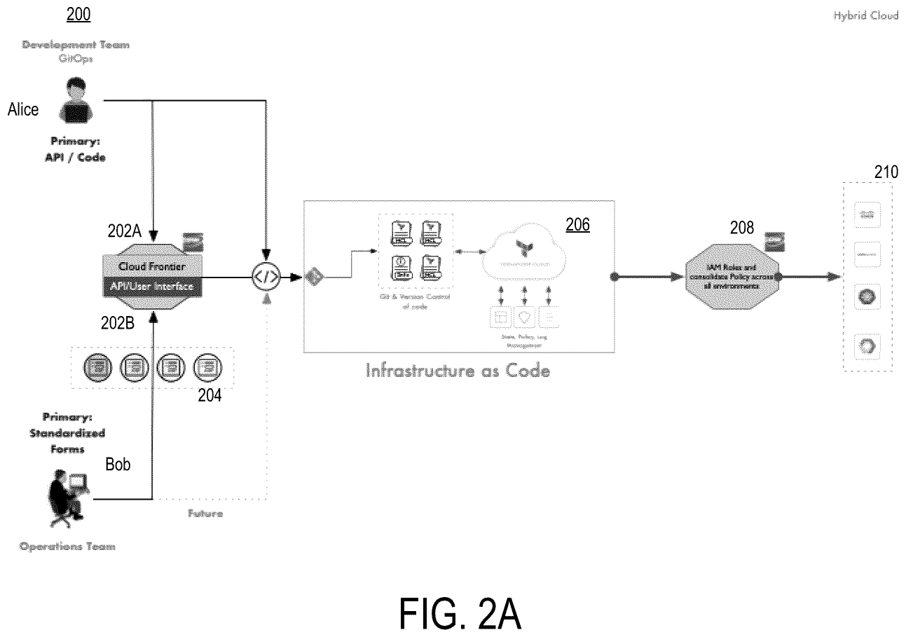

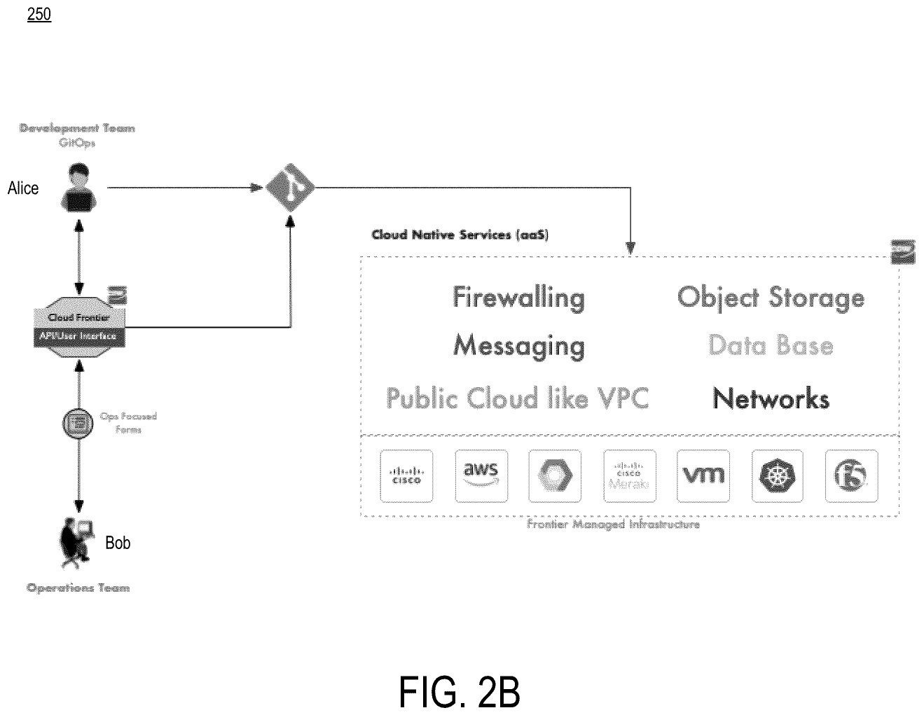

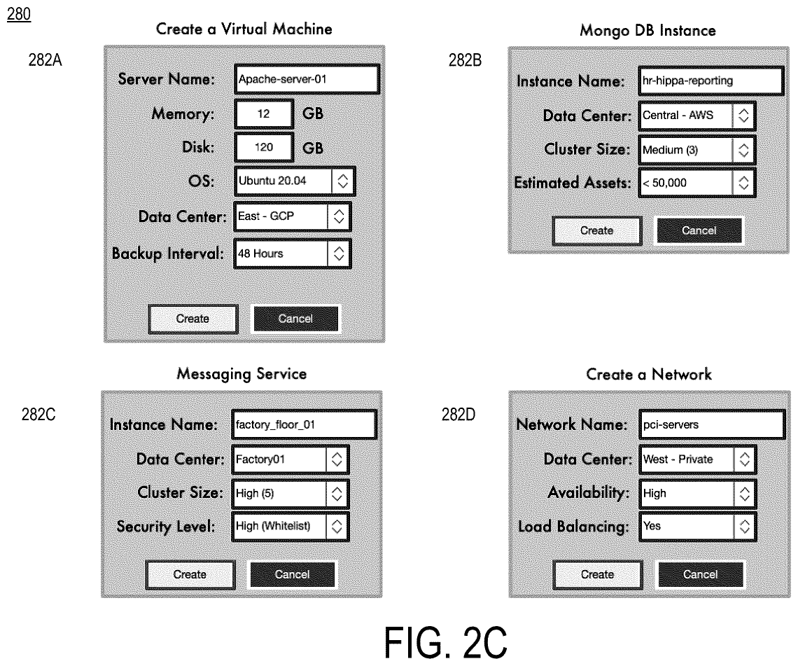

FIG. 2A depicts an exemplary system 200 for providing access to a cloud computing environment 210 across functional teams, according to some aspects. This system 200 may include an API facet 202A that allows DevOps users or other users whose primary mode of access to the cloud computing environment 210 is via an API or pure code to access the cloud computing environment. The system 200 may further include a forms facet 202B that allows operations team or IT team users whose primary mode of access is via standardized forms to access the cloud computing environment. The system 200 may include a forms layer 204 that includes computer-executable instructions that translate requests received via the standardized forms into API calls that the API facet 202A can process directly.

The API facet 202A may include a set of computer executable instructions that translate requests from users into instructions for an infrastructure as code module 206. For example, the computer executable instructions may generate configuration files for one or more open source infrastructure as code software packages such as Terraform or Ansible.

For an example of cross-functional operation, consider an organization that includes two users, Alice and Bob. With reference to FIG. 1A, Alice may be the user 106A whereas Bob is the user 106 B. As shown in FIG. 1A, Alice may already be accessing an infrastructure as code environment to administer and access cloud environments. On the other hand, Bob may be using a hodgepodge of different cloud management tools that provide an inconsistent user interface to various aspects of cloud management. Because Bob's tools for cloud management are not harmonized, Bob has a lot more complexity to track and is generally all other things being equal going to be a lot less efficient than Alice.

In the example of FIG. 2A, Alice is a member of the DevOps team and works primarily using direct APIs and via drafting snippets of code to manipulate the hybrid cloud computing environment 210. For example Alice may want to permission a new user to access a specific environment or to create a policy rule that will apply to all users across all environments. In order to do this, Alice typically writes code or executes instructions in a shell to cause infrastructure as code to be generated that includes different IAM roles or policies with respect to one or more computing environments. Unlike prior systems that require Bob to access multiple different environments to perform the same cloud management operations, the computing system 200 includes the graphical user interface layer 204 that provides Bob with a harmonized and consistent user interface for any underlying cloud platform components whether those components are located in a public cloud an on premise environment or in a private cloud or hybrid cloud setup.

Now, the actions of Alice and Bob regardless of whether they are entered directly via the API facet 202A or the graphical user interface layer 204, results in the exact same infrastructure as code instructions. Thus, the present techniques advantageously move conventional IT personnel in the direction of using infrastructure as code, a specialized and systematized framework for performing cloud management operations, while still falling short of requiring such legacy users to learn an entirely new low level programming skill. Thus, the present techniques improve cloud computing management systems by leveling the playing field for all users, and by reducing many disparate graphical user interfaces into a single access point while also preserving the ability of users to access the cloud environment 210 using APIs directly, if they so choose. Examples of the user interface layer are provided below.

### Exemplary Cloud Native Services Aspects

FIG. 2B depicts an exemplary system 250 for providing access to cloud native services across functional teams. Just as FIG. 2A depicts a system 200 for providing access to different functional teams, and users with different skill levels using a consistent interface, the system 250 enables users to access cloud native services using graphical user interfaces, or via direct APIs/code. This enables the present techniques to be used in the provision of managed services to customers. And further, this enables the present techniques to be used to build higher-level tools. For example, it is increasingly the case that many organizations simply do not want to manage their own cloud computing infrastructures. In such a case, the customer can get rid of infrastructure as code and simply hire a company that uses the system to 50 to manage their cloud infrastructure. In that case assets, reporting, change tickets, and change management may be used to communicate desired changes. The system 250 also enables cloud native services such as a Mongo DB to be offered to customers through infrastructure as code providers (for example terraform). Thus, the present techniques may be used with an IT Service Management system (e.g., CDW ServiceNow) to offload cloud management from customers.

### Exemplary Graphical User Interfaces Aspects

FIG. 2C depicts exemplary graphical user interface forms 280, according to some aspects of the present techniques. For example, FIG. 2C depicts a form 282A for creating a virtual machine, a form 282B for creating a database instance, a form 282C for creating a messaging service and a form 282D for creating a network. Of course, the forms 282 may include deleting and editing components, in some aspects. The forms may correspond to the Ops focused forms of FIG. 2B and the forms layer 204 of FIG. 2A, in some aspects.

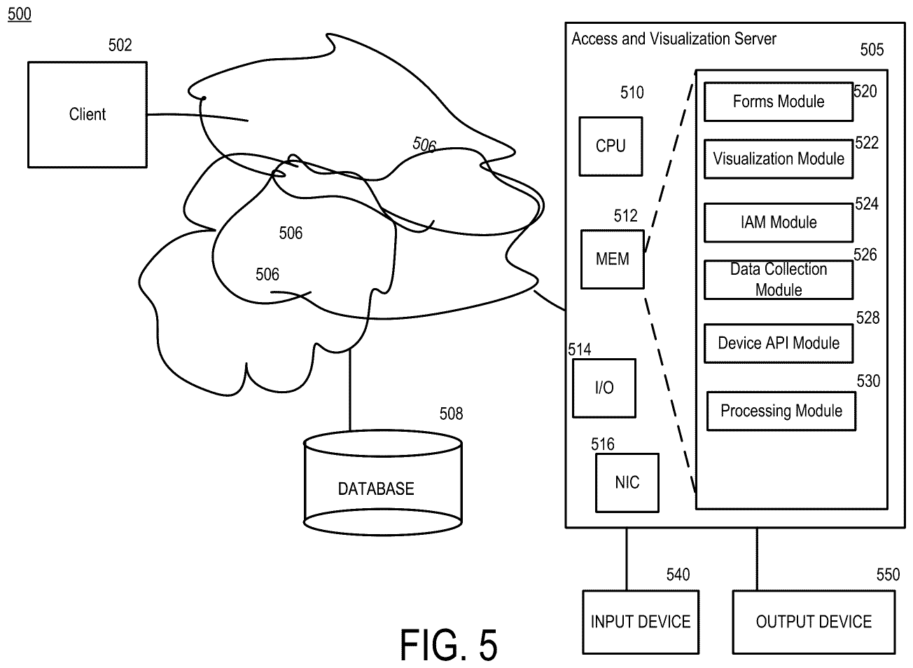

In some aspects, the forms 282 may be generated automatically based on configuration files. For example, with respect to FIG. 2A for example, when the infrastructure as code 206 uses terraform, the forms 204 may be automatically generated buy a forms generation module (depicted in FIG. 5) that processes HashiCorp Configuration Language (HCL) files. The HCL files may be created by, for example, a DevOps user directly.

### Exemplary Cloud Computing Visibility Aspects

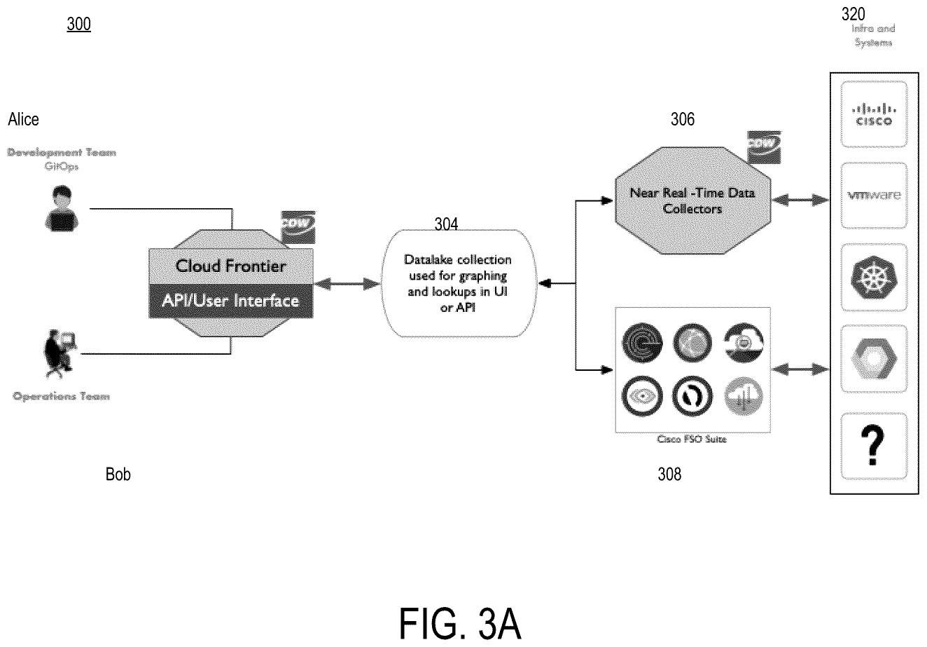

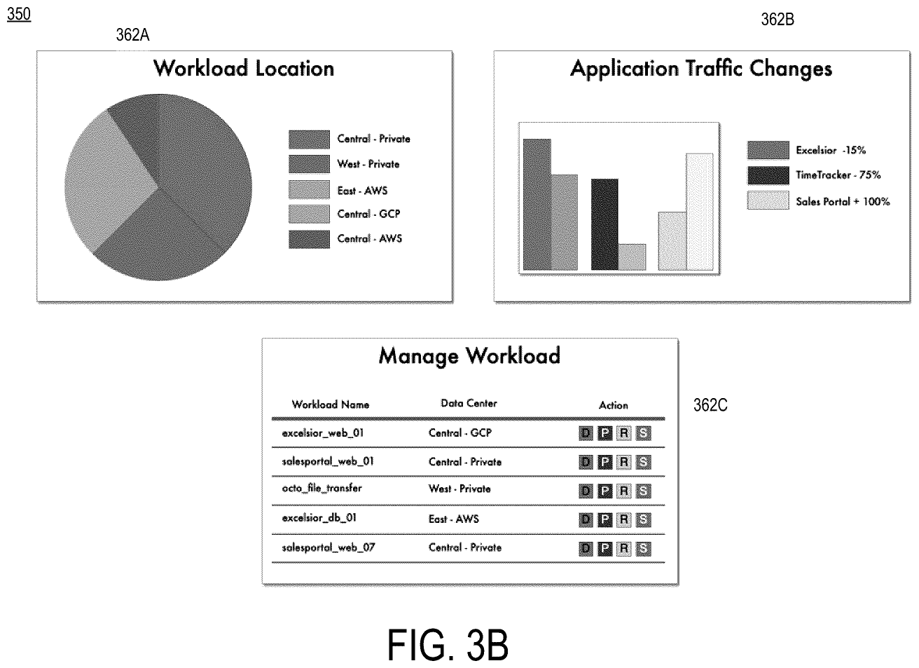

FIG. 3A depicts an exemplary system 300 for providing visibility of a cloud computing environment 320 across different functional teams. Again, the system 300 is being accessed by Alice, a member of the DevOps team, and Bob, who works in conventional IT. As with access to the hybrid cloud being facilitated by a common interface to an infrastructure as code system, the present techniques include using the system 300 to provide a common interface to a data lake 304 that can be used to visualize and or search monitoring data with respect to the cloud computing environment 320. With respect to FIG. 1B, it is clear that in conventional systems, IT users and DevOps users did not access infrastructure and system monitoring data via a similar mechanism, and such users had no expectation whatsoever that such data would be presented in a cohesive or uniform manner. For example, Alice would be expecting to see near real time data collector information, and Bob would be expecting to see FSO information.

Thus, to provide users across functional teams with a uniform view of cloud monitoring data, the present techniques may use the aforementioned graphical user interfaces to enable operations team members to query for information. Further, the present techniques include consolidating output from multiple monitoring sources such as a near real time data collector 306 and an FSO suite 308. For example, the data lake 304 may be a time series database. In some aspects Grafana may be used for storage and visualization purposes. The data lake advantageously provides users regardless of their functional team, with a uniform in generalized view of data with respect to cloud performance. Doing so simplifies programming interfaces and communication between teams.

For example, FIG. 3B depicts exemplary standardized visualizations 350 that may be generated (e.g., by a visualization generation module, depicted in FIG. 5) based on the data in the data lake 304 of FIG. 3A. Specifically, FIG. 3B depicts a workload pie chart 362A with respect to multiple cloud environments, application traffic change bar chart 362B with respect to multiple services, and an interactive workload management panel 362C that enables users to graphically control execution of one or more cloud-based workloads. Of course, many additional visibility elements are envisioned, including those that enable monitoring and graphing over time, data visualization queries, historical workloads vs. current workloads, etc.

### Exemplary Cloud Frontier Computing System Architecture

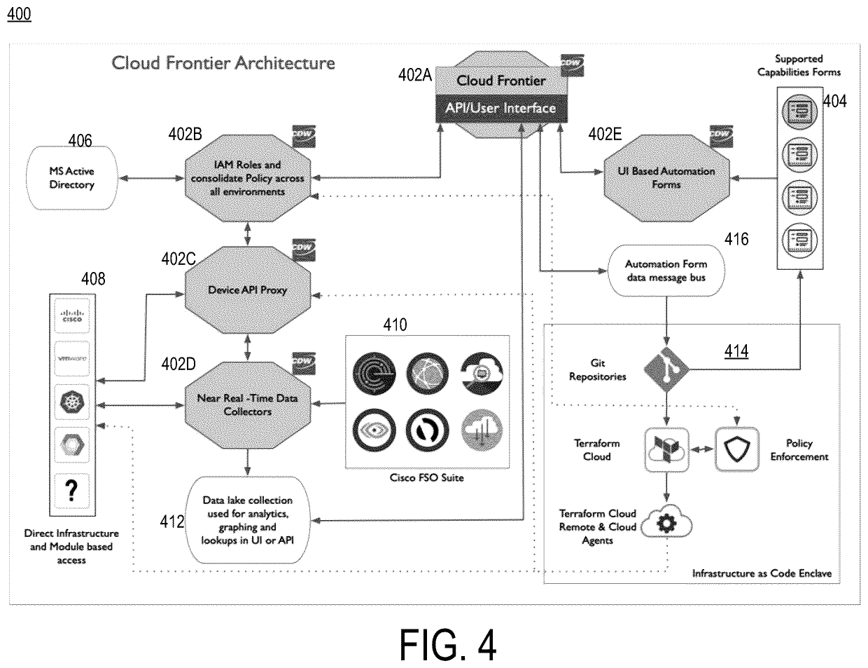

FIG. 4 depicts an exemplary high level cloud computing system architecture diagram 400, according to some aspects of the present techniques. FIG. 4 shows how the functionality of FIG. 3A-FIG. 3B may be pulled together to provide a holistic system for managing cloud resources by teams across different functional groups. The architecture 400 depicts several components that, in concert, advantageously enable teams across different functional groups to access (e.g., deploy, manage) and view (e.g., monitor) hybrid cloud computing resources though an integrated and unified mechanism, regardless of whether the underlying cloud is entirely on-premises, in the cloud, or a hybrid.

For example, the architecture 400 includes several pluggable modules 402, including a cloud frontier and API/user interface module 402A, an identity and access management (IAM) module 402B, a device API proxy module 402C, a near real-time data collector module 402D and a UI-based automation/forms module 402E.

The cloud frontier and API/user interface module 402A may include computer-executable instructions for connecting user interfaces with other aspects of the architecture 400. For example, the module 402A may include instructions for receiving IAM role additions, modifications, or deletions from the module 402E, entered by a user via one or more GUI forms 404 or via one or more APIs, and for converting those modification roles into entries within an Active Directory database 406. Specifically, the module 402A may include functionality that enables users to administer roles (e.g., control access to projects or resources) via code (e.g., by DevOps users) or via a user interface (e.g., via IT operations users).

In general, the architecture 400 shows the features of FIG. 2A-2C, combined with the features of FIG. 3A-3B, along with additional components that may be optionally included, according to the wants of the customer. For example, the device API proxy 402C may be optional in some circumstances. The GUI forms 404 may correspond to the GUI layer 204 of FIG. 2A and/or forms used by Bob in FIG. 3A, in some aspects. Thus, when fully deployed, the present techniques may include suites of forms that enable users to perform access/and or visibility-related tasks with respect to one or more cloud environment.

In some aspects, the entirety of the architecture 400 may be packaged and sold to a customer, either as a solution got the customer deploys in their own architecture, or as a managed service. The pluggable architecture including the various pluggable modules 402 advantageously enable customers in different market sectors to choose exactly the components they want and to leave behind those that had no value for their particular use case. For example a bank or another entity that has high compliance burden may choose a cloud deployment that is entirely on premise because public clouds or hybrid clouds do not provide adequate security guarantees. Nevertheless all of the customer's data can still be directed into a data lake 412 that has all of the visualization capabilities described above. Furthermore, for the same organization, users from different cross functional teams such as DevOps and traditional IT are still able to use the cloud frontier facet 402A to access various parts of the on premise cloud instance via forms or more low level code based methods.

### Exemplary Computing Environment

FIG. 5 depicts an exemplary computing environment 500, in which the techniques disclosed herein may be implemented, according to some aspects. The environment 500 includes a client computing device 502, a server 504, and a network 506. Some embodiments may include a plurality of client computing devices 502 and/or a plurality of servers 504.

The client computing device 502 may be an individual server, a group (e.g., cluster) of multiple servers, or another suitable type of computing device or system (e.g., a collection of computing resources). For example, the client computing device 502 may be any suitable computing device (e.g., a server, a mobile computing device, a smart phone, a tablet, a laptop, a wearable device, etc.). In some embodiments, one or more components of the private cloud 102 may be embodied by one or more virtual instances (e.g., a cloud-based virtualization service). In such cases, one or more client computing device 502 may be included in a remote data center (e.g., a cloud computing environment, a public cloud, a private cloud, etc.).

The network 506 may be a single communication network, or may include multiple communication networks of one or more types (e.g., one or more wired and/or wireless local area networks (LANs), and/or one or more wired and/or wireless wide area networks (WANs) such as the Internet). The network 506 may enable bidirectional communication between the private cloud 102 and the server 104, and/or between multiple client private clouds 102, for example. As shown, the network 506 may include one or more overlapping or separate cloud computing networks, such as one or more public clouds, one or more private clouds and/or one or more hybrid clouds.

The client private cloud 102 may include a processor and a network interface controller (NIC). The processor may include any suitable number of processors and/or processor types, such as CPUs and one or more graphics processing units (GPUs). Generally, the processor is configured to execute software instructions stored in a memory. The memory may include one or more persistent memories (e.g., a hard drive/solid state memory) and stores one or more set of computer executable instructions/modules. In general, a proprietor (e.g., developer) or customer user may access the cloud computing environments via the network 506 via the client 502.

The server 504 includes a processor 510, a memory 512, an I/O controller 514 and a NIC 516. The server 504 may access the database 508 via the networks/cloud environments 506. The database 508 may be a structured query language (SQL) database (e.g., a MySQL database, an Oracle database, etc.) or another type of database (e.g., a not only SQL (NoSQL) database). The server 504 may include a library of client bindings for accessing the database 508. The database 508 may be separate from any databases initialized as part of a cloud computing environment, whether or not on behalf of customer.

The processor 510 may include any suitable number of processors and/or processor types, such as CPUs and one or more graphics processing units (GPUs). Generally, the processor 510 is configured to execute software instructions stored in a memory 512. The memory 512 may include one or more persistent memories (e.g., a hard drive/solid state memory) and stores one or more set of computer executable instructions/modules, including a forms module, a visualization module 522, an IAM module 524, a data collection module 526, a device API module 528 and a command processing module 530. Each of the modules implements specific functionality related to the present techniques.

The forms module 520 may include a set of computer executable instructions for processing one or more configuration files such as terraform configuration files to generate one or more forms by which user input may be collected. For example, those forms may correspond to the forms depicted in FIGS. 2A through 3B. The visualization module 522 may include a set of computer executable instructions for generating one or more visualizations. For example the visualizations may correspond to those depicted in FIGS. 3A and 3B, wherein the data lake is used as the source of data for the visualizations. the IAM module 524 may include a set of computer executable instructions for generating Active Directory rules based on user defined preferences. The data collection module 526 may include instructions for collecting data from one or more data sources, such as a Cisco FSO suite such as the suite 510 depicted in FIG. 5 and/or from real time data collectors that are part of a public cloud infrastructure. The device API module 528 may include a set of computer executable instructions for passing through data as a proxy. This proxy may be used to control access to on premises resources. Processing module 530 may include a set of computer executable instructions for receiving and processing user commands with respect to the cloud environment. For example the processing module may include instructions for determining whether a given command is an API call from user code or a command that was issued via one or more electronic forms. The processing module 530 may include instructions for generating one or more infrastructure as code rules and for storing those roles in an infrastructure as code management systems such as terraform. The processing module 530 may also include instructions for communicating a status code to a device such as the client device 502 wherein the result represents the status of the user command as being either successful, unsuccessful, in progress, etc. based on the processing of the user command.

The input output controller 514 may include instructions for processing inputs from an input device 550 and for generating outputs for an output device 550. The input device 550 and the output device 550, respectively, enable input to be received from a user for example from a keyboard or mouse or other input device, and for outputs that correspond to be generated and transmitted to the output device. In some cases, the input device 550 and the output device 550 maybe combine into a single device such as a capacitive touch screen.

As noted, the network 506 may include a plurality of cloud deployments for one or more different customers. For example the network 506 may include a private cloud of a first customer and a public cloud of the same customer. The network 506 may further include a second private cloud belonging to a second customer. The network 506 may further include a plurality of hybrid cloud instances that correspond to yet a third customer. The database 508 may include tables and databases that are used to track the various cloud deployments such that the access and visualization server 504 is able to provide access and visualization to each of the respective cloud deployments and to each of the respective customers. The client 502 may enable each of the customers to access and visualize information about the one or more clouds with which they are associated using the system and environment 500.

### Exemplary Computer-Implemented Methods

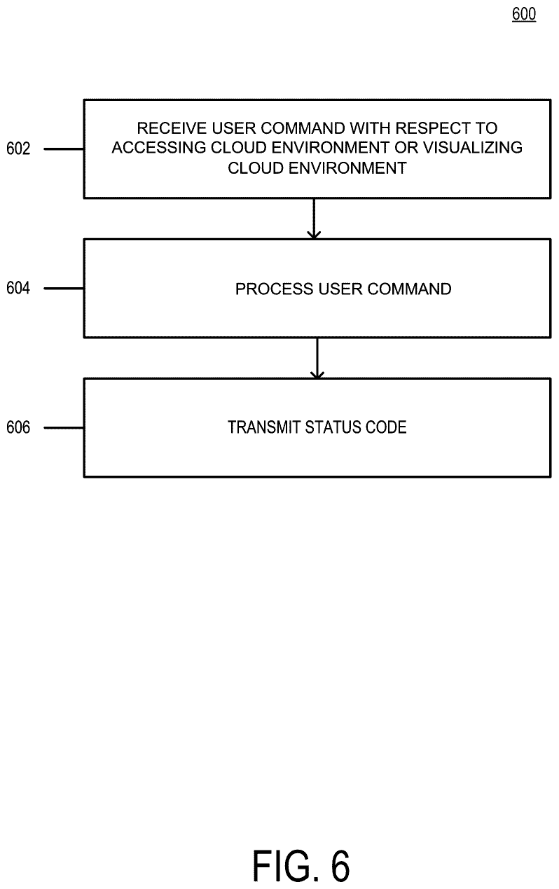

FIG. 6 depicts an exemplary computer-implemented method 600 for providing cross-functional access and visibility to one or more cloud computing environments, according to some aspects of the present techniques. The method 600 may be performed by one or more components of the computing environment 500 of FIG. 5, in some aspects.

The method 600 may include receiving a user command with respect to one or both of (i) accessing the cloud environment, and (ii) visualizing the cloud environment (block 602).

The method 600 may include processing the user command, wherein the processing causes one or more cloud functions to be performed affecting the state of the cloud environment (block 604).

The method 600 may include transmitting a status code based on the processing of the user command (block 606).

In some aspects, the method 600 may further include determining that the user command is an API command of a DevOps user.

In some aspects, the one or more cloud functions include at least one of (i) creating, modifying or deleting a virtual machine, (ii) creating modifying or deleting an electronic database, (iii) creating, modifying or deleting a messaging service, (iv) creating, modifying or deleting an electronic network, or (v) creating, modifying or deleting an IAM role or policy.

In some aspects, the method 600 may include generating one more visualizations of data corresponding to at least one of the cloud environments.

In some aspects, the method 600 may include creating, modify or delete one or more configuration files used to parameterize an infrastructure-as-code computing platform.

### Exemplary Computer-Implemented Graphical User Interfaces

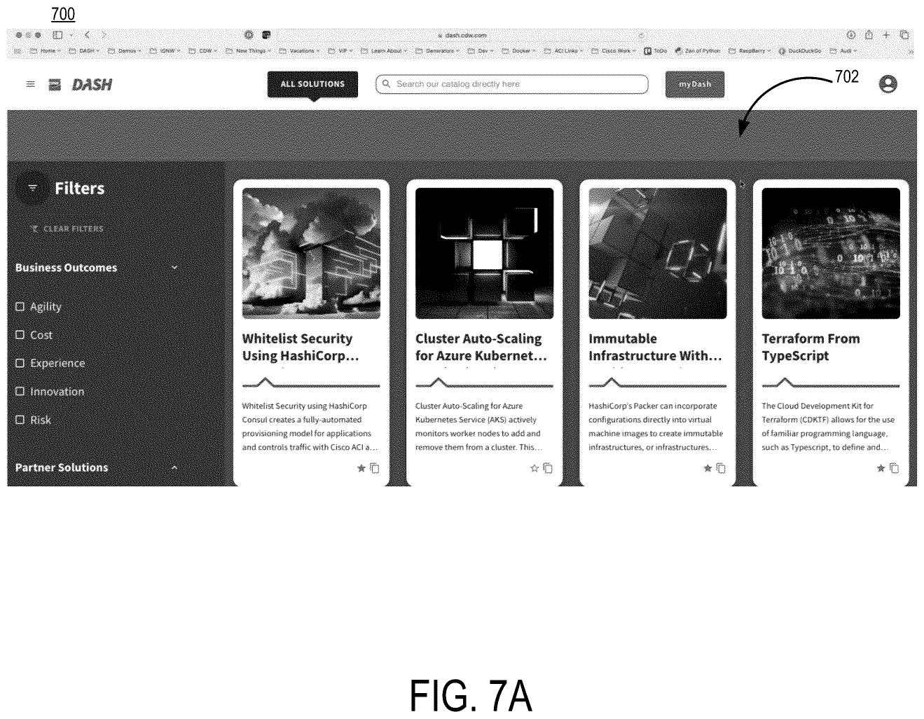

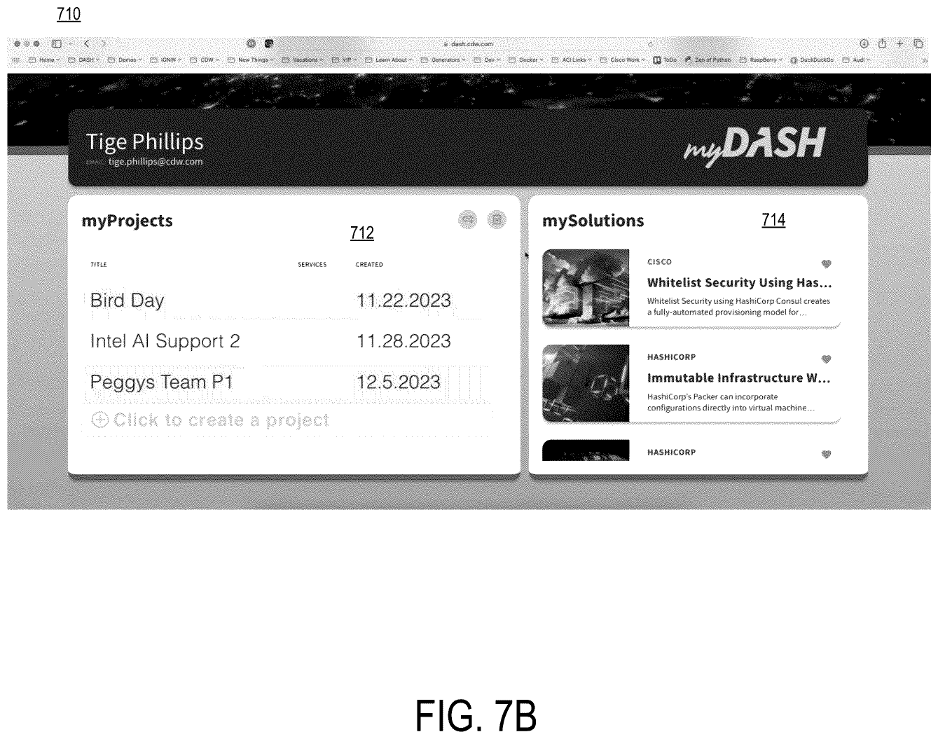

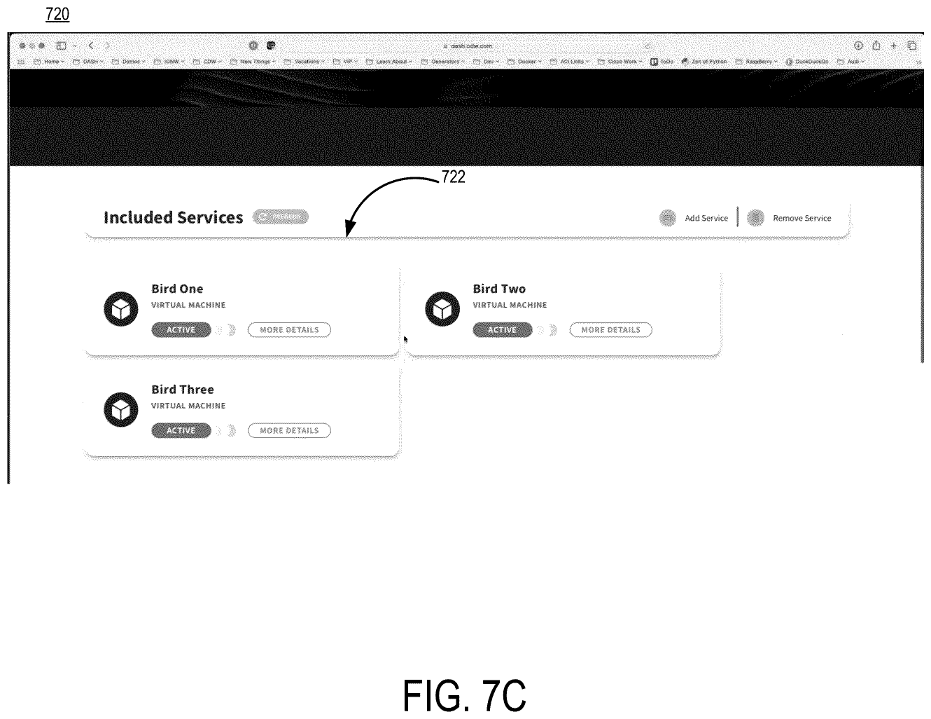

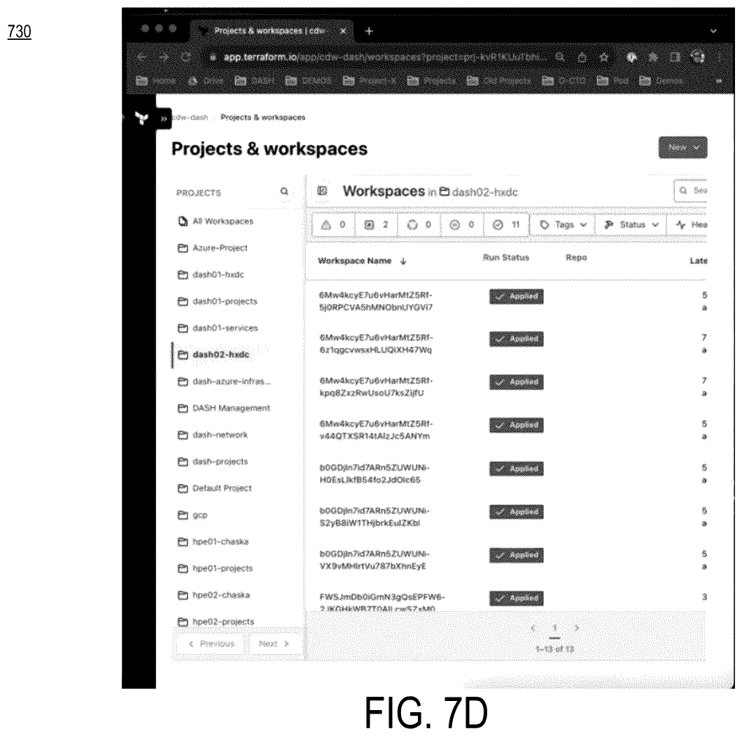

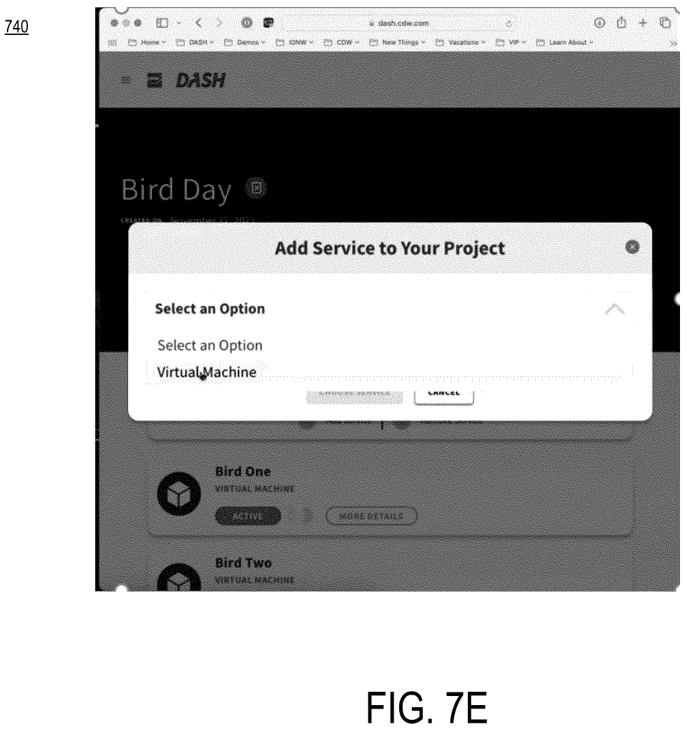

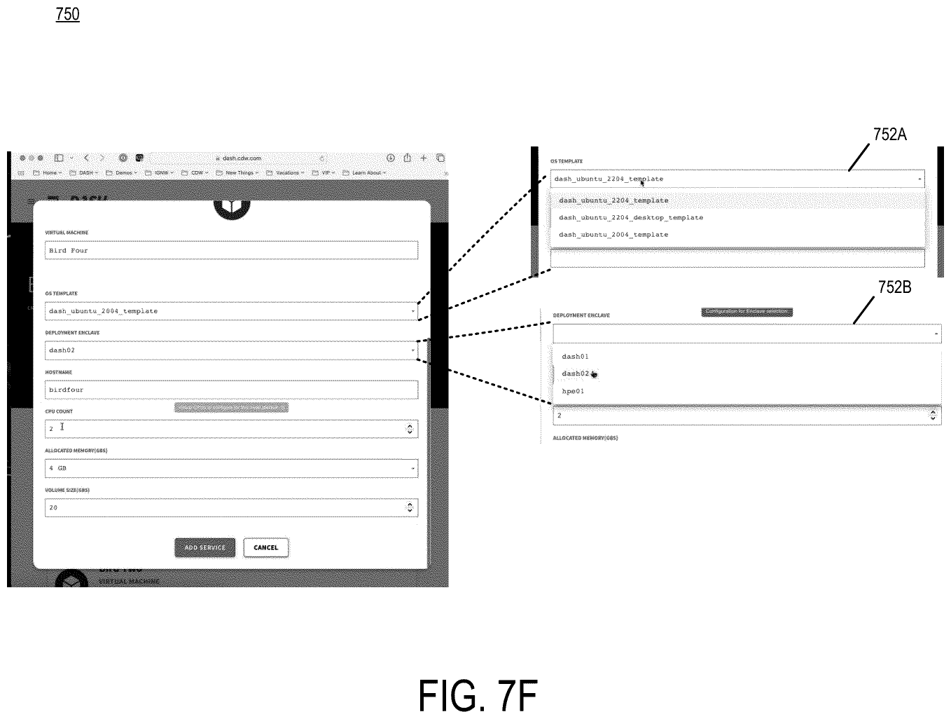

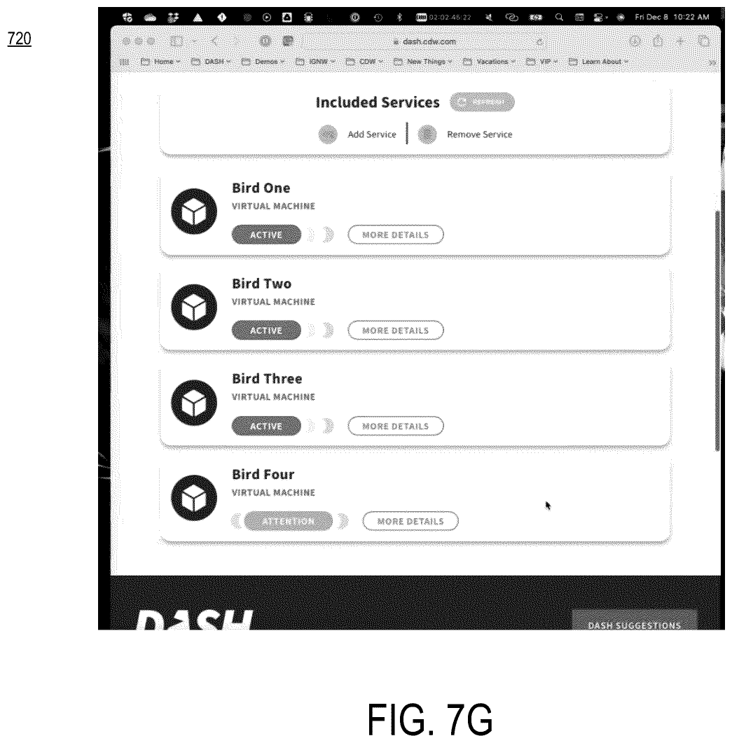

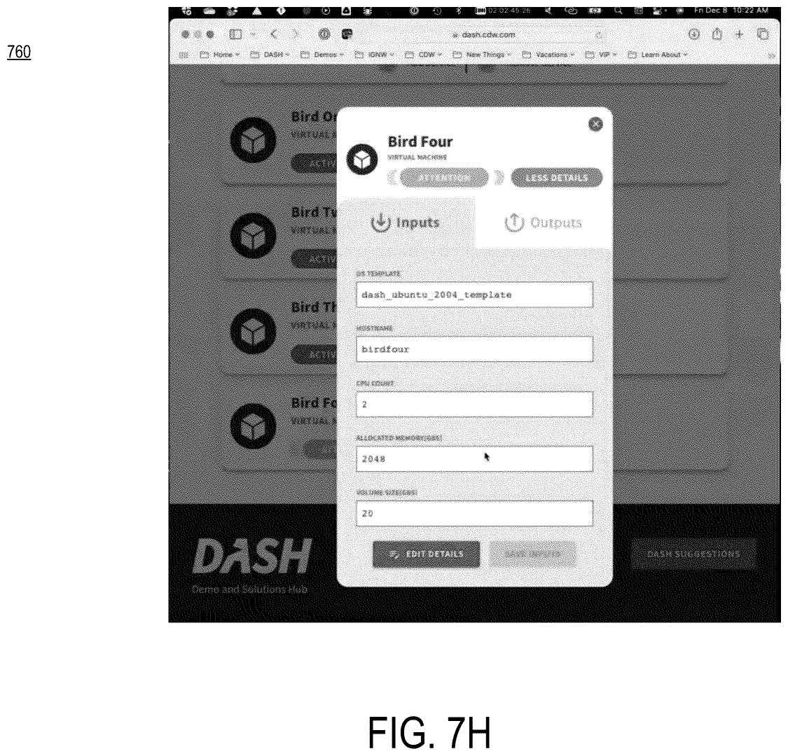

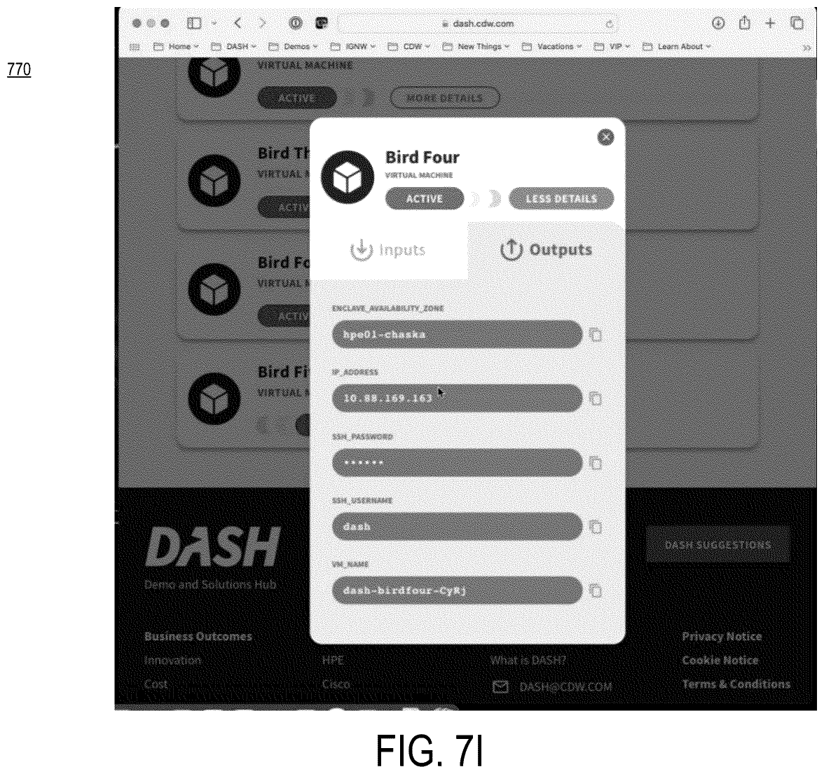

FIG. 7A depicts a graphical user interface 700 depicting custom infrastructure-as-code management solutions 702 available to customers, according to some aspects. The custom infrastructure-as-code management solutions 702 may include solutions for security whitelisting, cluster auto-scaling, immutable infrastructures, terraform management, etc. The graphical user interface 700 may allow the user to select and purchase or enable one or more of the custom infrastructure-as-code management solutions 702 within the customer's account, associated with the system 200 of FIG. 2A, for example. The access and visualization server 505 of FIG. 5 may include instructions for displaying the graphical user interface 700 and for enabling the services corresponding to the selected custom infrastructure-as-code management solutions 702. For example, the device API module 528 may include instructions for displaying available custom infrastructure-as-code management solutions 702 and for modifying a customer profile in the database 508 when the customer selects the custom infrastructure-as-code management solutions 702.

FIG. 7B depicts a customer graphical user interface 710, according to some aspects. The customer graphical user interface 710 includes a list of projects 712 and a list of solutions 714. The list of solutions 714 may correspond to the custom infrastructure-as-code management solutions 702 that the customer selected in FIG. 7A, according to some aspects. The data corresponding to the customer displayed in customer graphical user interface 710 may be stored in the database 508. The customer graphical user interface 710 enables the customer to track the projects that the customer has, and the solutions that the customer has enabled within those projects.

FIG. 7C depicts a services graphical user interface 720, according to some aspects. The services graphical user interface 720 may include a list of one or more virtual machines 722, for example. The user may add or remove services using the services graphical user interface 720, and may click on individual services (e.g., the list of one or more virtual machines 722) to view details about each of the respective services.

FIG. 7D depicts an infrastructure-as-code management graphical user interface 730, according to some aspects. The infrastructure-as-code management graphical user interface 730 is a complex user interface typically used by advanced users (e.g., DevOps users). In some aspects, the present techniques exist to avoid forcing users to access the infrastructure-as-code management graphical user interface 730. This provides a practical improvement to infrastructure-as-code systems, which are typically designed for advanced users and lack simplified graphical user interfaces.

FIG. 7E depicts an add service infrastructure-as-code graphical user interface 740, according to some aspects. The graphical user interface 740 enables the user (e.g., the customer) to add a new virtual machine, such as one of the one or more virtual machines 722. In some aspects, other services may be included such as one or more databases, one or more server instances, one or more network objects, etc.

FIG. 7F depicts a virtual machine creation graphical user interface 750, according to some aspects. The virtual machine creation graphical user interface 750 includes virtual machine parameters including a virtual machine name input field, an OS template input field 752A, a deployment enclave input field 752B, a hostname input field, a CPU count input field, an allocated memory input field, and a volume input field, according to some aspects. The 725A// enables the user to select from one or more operating system templates for the new virtual machine. The deployment enclave input field 752B enables the user to select from one or more deployment enclaves for the new virtual machine. The deployment enclave input field 752B illustrates another improvement of the present techniques; namely, that the enclaves may support different cloud vendors. For example, in the deployment enclave input field 752B, the enclaves may be are HP (hpe01) and Cisco (dash01, dash02) based. Additional cloud vendors may be added (e.g., Amazon Cloud, Google Cloud Platform, etc.). Thus, the present techniques are seen to be further advantageous to end users who lack expert-level knowledge, by still allowing them to provision a private cloud having heterogeneous instances, while using a simplified interface.

FIG. 7G depicts an updated services graphical user interface 720, according to some aspects, wherein a fourth virtual machine has been added. The list of one or more virtual machines 722 now includes a fourth virtual machine (Bird Four) added using the graphical user interface 740, for example.

FIG. 7H depicts a virtual machine detail graphical user interface 760, according to some aspects. The virtual machine detail graphical user interface 760 includes virtual machine parameters corresponding to the virtual machine parameters of virtual machine creation graphical user interface 750. The virtual machine detail graphical user interface 760 enables the user to update and modify the virtual machine parameters, to change the behavior of the virtual machine. When the user makes a change, or creates the virtual machine using the virtual machine creation graphical user interface 750 the respective graphical user interface may cause the change to be processed. For example, the user interface 750 (or any of the other user interfaces in FIGS. 7A-7I) may include instructions that, when executed, cause a form such as the 770// to be processed. For example, the access and visualization server 505 may include a further module (not depicted) that processes forms. The form processing module may generate new services and add them to the database 508 in association with the customer's account; update existing services in the database 508 that are associated with the user's account; delete services from the database 508, etc. The virtual machine detail graphical user interface 760 may cause infrastructure as code templates to be executed (e.g., a Terraform template). It should be appreciated that this facilitates the provision and editing of infrastructure-as-code components, without the need for the user to understand or make any API calls. Instead, the form processing module may include logic for transforming the user's use of the present user interfaces into API calls against one or more backend services, as discussed with respect to FIG. 2A and FIG. 5.

Personnel who understand infrastructure-as-code and automation tools (e.g., Terraform) can still use a backend registry to create VMs in an advanced user interface, or the more simplified interface of FIGS. 7A-7H. This represents an advantageous improvement, by allowing the user to still get things done in an infrastructure-as-code environment using a simpler interface.

FIG. 7I depicts a virtual machine configuration graphical user interface 770, according to some aspects. FIG. 7I illustrates another benefit of the present techniques. In particular the virtual machine configuration graphical user interface 770 enables extraction of data fields important to the user such as enclave availability zone, IP address, SSH username, SSH password, virtual machine name, etc. that would otherwise be locked away in infrastructure as code configuration files that the typical non expert user might not know how to access or might have great difficulty accessing. having to search for these fields, the user is able to quickly efficiently access them. For example, the user interfaces depicted in FIGS. 7A-7I may be displayed on a user interface of the forms facet 202B of FIG. 2A, in some aspects. The present techniques may integrate with a reporting and analysis system.

In some aspects, the user interfaces in FIGS. 7A-7I may be licensed to others. For example, some of the functionality depicted in FIG. 2A (e.g., some or all of the system 200) may be provided to an entity such as a state government, a federal government, a private business, etc., under a rental or purchase agreement. For example, the system 200 may be hosted as a private cloud that the lessee has access to. The lessee may then use the system 200 to configure VMs (e.g., the list of one or more virtual machines 722). In that case, the system 200 may be rebranded, for example, to have a URL associated with the customer. The system 200 may run in the environment of the customer, but may not be distributed. For example, the system 200 may be managed and owned by the proprietor of the system 200, but located inside the firewalls and inside the network of the lessee/customer. The customer may retain physical control, while providing logical control to the proprietor of the present techniques. The proprietor may maintain one or more tunnels enabling the proprietor to connect to and manage the lessee/customer's environment 100.

Some customers may have a need to manage and create private cloud environments in a GUI-based and automated way, in a particular geographic region (e.g., a U.S. company that needs a Canada-based or European Union-based private cloud). The present techniques enable that to be accomplished easily via managed services. Further, if the customer already has an existing infrastructure-as-code environment (e.g., a Terraform-based environment), then the present techniques may be used to add a simplified administrative layer to that environment, without affecting the underlying system. The present techniques may include tagging existing assets in a “brownfield” environment (i.e., an environment in which infrastructure-as-code components are already deployed) and new assets using different tags. This tagged information may be stored in the data lake 304A, for example, to enable reporting and monitoring the existing system using the tags to filter the system. Thus, the present techniques can be used to quickly add filtered logs to an existing infrastructure-as-code system.

### EXEMPLARY ASPECTS

The various embodiments described above can be combined to provide further embodiments. All U.S. patents , U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system for improving access and visualization of one or more cloud computing environments across functional groups, comprising: one or more processors; one or more electronic networks; and a memory having stored thereon instructions that, when executed by the one or more processors, cause the system to: receive, via the one or more electronic networks, a user command with respect to one or both of (i) accessing at least one of the cloud environments, and (ii) visualizing at least one of the cloud environments; process, via the one or more processors, the user command, wherein the processing causes one or more cloud functions to be performed affecting the state of at least one of the cloud environments; and transmit, via the one or more electronic networks, a status code based on the processing of the user command.
2. The system of aspect 1, the memory having stored thereon instructions that when executed by the one or more processors, cause the system to: determine that the user command is an API command of a DevOps user.
3. The system of any of aspects 1-2, the memory having stored thereon instructions that when executed by the one or more processors, cause the system to: determine that the user command is a GUI command of an IT user.
4. The system of any of aspects 1-3, wherein the one or more cloud functions include at least one of (i) creating, modifying or deleting a virtual machine, (ii) creating modifying or deleting an electronic database, (iii) creating, modifying or deleting a messaging service, (iv) creating, modifying or deleting an electronic network, or (v) creating, modifying or deleting an IAM role or policy.
5. The system of any of aspects 1-4, the memory having stored thereon instructions that when executed by the one or more processors, cause the system to: generate one more visualizations of data corresponding to at least one of the cloud environments.
6. The system of any of aspects 1-5, wherein the visualizations include at least one of (i) a workload visualization, (ii) an application traffic change visualization, or (iii) an interactive workload management panel.
7. The system of any of aspects 1-6, the memory having stored thereon instructions that when executed by the one or more processors, cause the system to: create, modify or delete one or more configuration files used to parameterize an infrastructure-as-code computing platform.
8. A non-transitory, computer-readable medium having stored thereon computer-executable instructions that, when executed by one or more processors, cause a computer to: receive, via the one or more electronic networks, a user command with respect to one or both of (i) accessing at least one of the cloud environments, and (ii) visualizing at least one of the cloud environments; process, via the one or more processors, the user command, wherein the processing causes one or more cloud functions to be performed affecting the state of at least one of the cloud environments; and transmit, via the one or more electronic networks, a status code based on the processing of the user command.
9. The non-transitory computer-readable medium of aspect 8, having stored thereon instructions that when executed by one or more processors, cause a computer to: determine that the user command is an API command of a DevOps user.
10. The non-transitory computer-readable medium of any of aspects 8-9, having stored thereon instructions that when executed by one or more processors, cause a computer to: determine that the user command is a GUI command of an IT user.
11. The non-transitory computer-readable medium of any of aspects 8-10, wherein the one or more cloud functions include at least one of (i) creating, modifying or deleting a virtual machine, (ii) creating modifying or deleting an electronic database, (iii) creating, modifying or deleting a messaging service, (iv) creating, modifying or deleting an electronic network, or (v) creating, modifying or deleting an IAM role or policy.
12. The non-transitory computer-readable medium of any of aspects 8-11, having stored thereon instructions that when executed by one or more processors, cause a computer to: generate one more visualizations of data corresponding to at least one of the cloud environments.
13. The non-transitory computer-readable medium of any of aspects 8-12, wherein the visualizations include at least one of (i) a workload visualization, (ii) an application traffic change visualization, or (iii) an interactive workload management panel.
14. The non-transitory computer-readable medium of aspect 8-13, having stored thereon instructions that when executed by one or more processors, cause a computer: create, modify or delete one or more configuration files used to parameterize an infrastructure-as-code computing platform.
15. A computer-implemented method for improving access and visualization of one or more cloud computing environments across functional groups, the method comprising: receiving, via one or more electronic networks, a user command with respect to one or both of (i) accessing at least one of the cloud environments, and (ii) visualizing at least one of the cloud environments; processing, via one or more processors, the user command, wherein the processing causes one or more cloud functions to be performed affecting the state of at least one of the cloud environments; and transmitting, via the one or more electronic networks, a status code based on the processing of the user command.
16. The computer-implemented method of aspect 15, further comprising: determining that the user command is an API command of a DevOps user.
17. The computer-implemented method of any of aspects 15-16, further comprising: determining that the user command is a GUI command of an IT user.
18. The computer-implemented method of any of aspects 15-17, wherein the one or more cloud functions include at least one of (i) creating, modifying or deleting a virtual machine, (ii) creating modifying or deleting an electronic database, (iii) creating, modifying or deleting a messaging service, (iv) creating, modifying or deleting an electronic network, or (v) creating, modifying or deleting an IAM role or policy.
19. The computer-implemented method of any of aspects 15-18, further comprising: generating one more visualizations of data corresponding to at least one of the cloud environments.
20. The computer-implemented method of any of aspects 15-19, further comprising: creating, modify or delete one or more configuration files used to parameterize an infrastructure-as-code computing platform.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term “” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computing system for improving access and visualization of one or more cloud computing environments across functional groups, comprising:
one or more processors;
one or more electronic networks; and
a memory having stored thereon instructions that, when executed by the one or more processors, cause the system to:
receive, via the one or more electronic networks, a user command with respect to one or both of (i) accessing at least one of the cloud environments, and (ii) visualizing at least one of the cloud environments;
process, via the one or more processors, the user command, wherein the processing causes one or more cloud functions to be performed affecting the state of at least one of the cloud environments; and
transmit, via the one or more electronic networks, a status code based on the processing of the user command.

2. The system of claim 1, the memory having stored thereon instructions that when executed by the one or more processors, cause the system to:
determine that the user command is an API command of a DevOps user.

3. The system of claim 1, the memory having stored thereon instructions that when executed by the one or more processors, cause the system to:
determine that the user command is a GUI command of an IT user.
4. The system of claim 1, wherein the one or more cloud functions include at least one of (i) creating, modifying or deleting a virtual machine, (ii) creating modifying or deleting an electronic database, (iii) creating, modifying or deleting a messaging service, (iv) creating, modifying or deleting an electronic network, or (v) creating, modifying or deleting an IAM role or policy.

5. The system of claim 1, the memory having stored thereon instructions that when executed by the one or more processors, cause the system to:
generate one more visualizations of data corresponding to at least one of the cloud environments.

6. The system of claim 5, wherein the visualizations include at least one of (i) a workload visualization, (ii) an application traffic change visualization, or (iii) an interactive workload management panel.

7. The system of claim 1, the memory having stored thereon instructions that when executed by the one or more processors, cause the system to:
create, modify or delete one or more configuration files used to parameterize an infrastructure-as-code computing platform.

8. A non-transitory, computer-readable medium having stored thereon computer-executable instructions that, when executed by one or more processors, cause a computer to:
receive, via one or more electronic networks, a user command with respect to one or both of (i) accessing at least one of the cloud environments, and (ii) visualizing at least one of the cloud environments;
process, via the one or more processors, the user command, wherein the processing causes one or more cloud functions to be performed affecting the state of at least one of the cloud environments; and
transmit, via the one or more electronic networks, a status code based on the processing of the user command.

9. The non-transitory computer-readable medium of claim 8, having stored thereon instructions that when executed by one or more processors, cause a computer to:
determine that the user command is an API command of a DevOps user.

10. The non-transitory computer-readable medium of claim 8, having stored thereon instructions that when executed by one or more processors, cause a computer to:
determine that the user command is a GUI command of an IT user.

11. The non-transitory computer-readable medium of claim 8, wherein the one or more cloud functions include at least one of (i) creating, modifying or deleting a virtual machine, (ii) creating modifying or deleting an electronic database, (iii) creating, modifying or deleting a messaging service, (iv) creating, modifying or deleting an electronic network, or (v) creating, modifying or deleting an IAM role or policy.

12. The non-transitory computer-readable medium of claim 8, having stored thereon instructions that when executed by one or more processors, cause a computer to:
generate one more visualizations of data corresponding to at least one of the cloud environments.

13. The non-transitory computer-readable medium of claim 12, wherein the visualizations include at least one of (i) a workload visualization, (ii) an application traffic change visualization, or (iii) an interactive workload management panel.

14. The non-transitory computer-readable medium of claim 8, having stored thereon instructions that when executed by one or more processors, cause a computer:
create, modify or delete one or more configuration files used to parameterize an infrastructure-as-code computing platform.

15. A computer-implemented method for improving access and visualization of one or more cloud computing environments across functional groups, the method comprising:
receiving, via one or more electronic networks, a user command with respect to one or both of (i) accessing at least one of the cloud environments, and (ii) visualizing at least one of the cloud environments;
processing, via one or more processors, the user command, wherein the processing causes one or more cloud functions to be performed affecting the state of at least one of the cloud environments; and
transmitting, via the one or more electronic networks, a status code based on the processing of the user command.

16. The computer-implemented method of claim 15, further comprising:
determining that the user command is an API command of a DevOps user.

17. The computer-implemented method of claim 15, further comprising:
determining that the user command is a GUI command of an IT user.

18. The computer-implemented method of claim 15, wherein the one or more cloud functions include at least one of (i) creating, modifying or deleting a virtual machine, (ii) creating modifying or deleting an electronic database, (iii) creating, modifying or deleting a messaging service, (iv) creating, modifying or deleting an electronic network, or (v) creating, modifying or deleting an IAM role or policy.

19. The computer-implemented method of claim 15, further comprising:
generating one more visualizations of data corresponding to at least one of the cloud environments.

20. The computer-implemented method of claim 15, further comprising:
creating, modify or delete one or more configuration files used to parameterize an infrastructure-as-code computing platform.
